(19) United States
(12) Patent Application Publication
(10) Pub. No.: US 2007/0103358 A1
(43) Pub. Date: May 10, 2007

(54) Method for locating an appliance's remote control

(76) Inventor: Oran Joseph Bodner, Zichron Yaakov (IL)

Correspondence Address: ORAN JOSEPH BODNER, 2 HITTA ST., ZICHRON YAAKOV, 30900, IL

(21) Appl. No.: 11/164,019

(22) Filed: Nov. 8, 2005

(51) Int. Cl. G08C 19/12

(52) U.S. Cl. 341/176

(57) ABSTRACT

The present invention is designed to solve the problem of locating the remote control of an electronic appliance (TV, VCR, air conditioner, stereo, etc.), by means of a button located on the appliance that causes the remote-control to beep when pressed, much like those found on a cordless telephone.

People seem to spend much of their time searching for remote controls, mainly of the television set, but also of every other appliance that is operated with a remote control: air-conditioner, VCR, DVD, stereo. garage door, etc.

Every such device, that is operated by a remote control, should include a system for locating the remote control, as they often get lost (often between the sofa cushions [symbol] ).

This invention offers a method for solving this problem, which may (should) be made standard for appliances operated via a remote control unit. The method is a simple one: Have a small button on the front of the appliance that causes the remote control unit to beep when depressed (such a system has been in use with cordless telephones for years).

What is claimed is:

1. A method for locating the remote control unit of an appliance, by means of pressing a button located on the appliance that causes the remote control unit to sound an audible beep, which will aid the user in located said remote control unit.

2. The method of claim 1, wherein said appliance is a television set.

3. The method of claim 1, wherein said appliance is a VCR.

4. The method of claim 1, wherein said appliance is a DVD.

5. The method of claim 1, wherein said appliance is a stereo system or subset thereof.

6. The method of claim 1, wherein said appliance is an air-conditioner.

7. The method of claim 1, wherein said appliance is a car alarm.

8. The method of claim 1, wherein said appliance is a garage-door opener.
